(19) United States
(12) Patent Application Publication
(10) Pub. No.: US 2022/0215768 A1
(43) Pub. Date: Jul. 7, 2022

(54) FLIGHT DECK SYSTEM FOR DETERMINING CIRCLING APPROACH OBSTACLE PROTECTED AIRSPACE

(71) Applicant: Garmin International, Inc., Olathe, KS (US)

(72) Inventors: William A. Tuccio, Overland Park, KS (US); Jason E. Hewes, Paola, KS (US); Tiziano Bernard, Kansas City, MO (US); Eric W. Sargent, Gardner, KS (US); Joseph L. Komer, Shawnee, KS (US)

(21) Appl. No.: 17/140,816

(22) Filed: Jan. 4, 2021

(51) Int. Cl. G08G 5/02; G06F 3/0482; G06F 3/0484; G08G 5/00; B64D 43/00

(52) U.S. Cl. CPC G08G 5/025; G06F 3/0482; B64D 43/00; G08G 5/0021; G06F 3/04847

(57) ABSTRACT

A flight deck system for an aircraft includes a processor, a graphical interface for displaying flight-related information in the form of selectable items, a control interface for receiving a selection of the selectable items, and a non-transitory computer-readable storage medium for storing electronic representations of charts. The selectable items correspond to the electronic representations of charts, and the electronic representations of charts describe circling approaches and associated conditional criteria for operating the aircraft (e.g., proximate to an airport). The processor is configured to arrange the selectable items, receive a selection of the selectable items, identify a corresponding one of the electronic representations of charts, receive a condition associated with the aircraft, compare the condition to the conditional criteria for operating the aircraft to identify an applicable one of the plurality of circling approaches, and display the applicable one of the plurality of circling approaches on the graphical interface.

### BACKGROUND

The circling approach is a protocol designed to keep an aircraft above obstacles within a specified distance away from all landing surfaces. The circling approach varies based on the applicable flight rules and a variety of criteria.

### DRAWINGS

The Detailed Description is described with reference to the accompanying figures. The use of the same reference numbers in different instances in the description and the figures may indicate similar or identical items.

FIG. 1 is block diagram illustrating a system for displaying flight-related information for an aircraft, where the system is configured to receive a selection of the flight-related information, identify an applicable electronic representation of a chart based upon the selection, and display a circling area based upon comparing a condition associated with the aircraft to the applicable electronic representation of the chart in with example embodiments of the present disclosure.

FIG. 2 is a block diagram further illustrating the system of FIG. 1.

FIG. 3 is a diagrammatic illustration of a graphical interface, where flight-related information for an aircraft is displayed in accordance with an example embodiment of the present disclosure.

FIG. 4 is another diagrammatic illustration of the graphical interface illustrated in FIG. 3.

FIG. 5A is a flow diagram illustrating a method for displaying flight-related information for an aircraft, receiving a selection of the flight-related information, identifying an applicable electronic representation of a chart based upon the selection, and displaying a circling obstacle based upon comparing a condition associated with the aircraft to the applicable electronic representation of the chart in accordance with example embodiments of the present disclosure.

FIG. 5B is another flow diagram illustrating a method for displaying flight-related information for an aircraft, receiving a selection of the flight-related information, identifying an applicable electronic representation of a chart based upon the selection, and displaying a circling obstacle based upon comparing a condition associated with the aircraft to the applicable electronic representation of the chart in accordance with example embodiments of the present disclosure.

### DETAILED DESCRIPTION

A flight deck system can include electronic devices, such as integrated avionics systems, which are utilized by one or more aircraft operators (e.g., a pilot and/or a co-pilot) to navigate an aircraft. Integrated avionics systems may employ primary flight display(s) (PFDs), multifunction display(s) (MFDs), and electronic flight bags (EFBs) to furnish primary flight control, navigational, and other information to the flight crew of the aircraft. Additionally, the integrated avionics systems may also employ an avionics control and display unit (CDU), portable electronic devices (PEDs), applications, and/or other control devices that are configured to provide control functionality to the PFDs, the MFDs, and/or the EFB s.

There is a recognized need to provide the operator (e.g., pilot or co-pilot) with increased automation of aircraft operations. Aircraft operations requiring significant manual control and/or significant manual data entry are inefficient, increase heads-down time, and increase the risk of operator error. For example, when flying a circling approach (including a circling line of minima on a straight-in approach for example) determining obstacle protected airspace and unauthorized portions of the circling area require manual data entry and are not readily depicted for the pilot. For efficiency and/or safety of operation, it may be beneficial to provide such necessary flight information to the operator through an accessible and user-friendly interface.

Accordingly, flight deck systems and methods for operating flight deck systems for controlling an aircraft are described. In an embodiment, a flight deck system (e.g., integrated avionics system) for an aircraft includes a processor, a graphical interface for displaying flight-related information in the form of selectable items, a control interface for receiving a selection of the selectable items, and a non-transitory computer-readable storage medium for storing electronic representations of charts. Each selectable item corresponding to one of the electronic representations of charts. Each of the electronic chart representations describes one or more circling approaches and associated conditional criteria for operating an aircraft. The non-transitory computer-readable storage medium has computer executable instructions stored thereon for execution by the processor to arrange the selectable items on the graphical interface and receive a selection of one of the selectable items. In response to the selection, the processor is operable to identify a corresponding one of the electronic representations of charts, receive at least one condition associated with the aircraft, and compare the condition to the conditional criteria described by the identified electronic chart representation to identify applicable circling approaches. The processor is further operable to display the applicable circling approaches on the graphical interface. In some embodiments, the processor is further operable to display the applicable circling approach to scale, for example, on a map.

### Example Embodiments

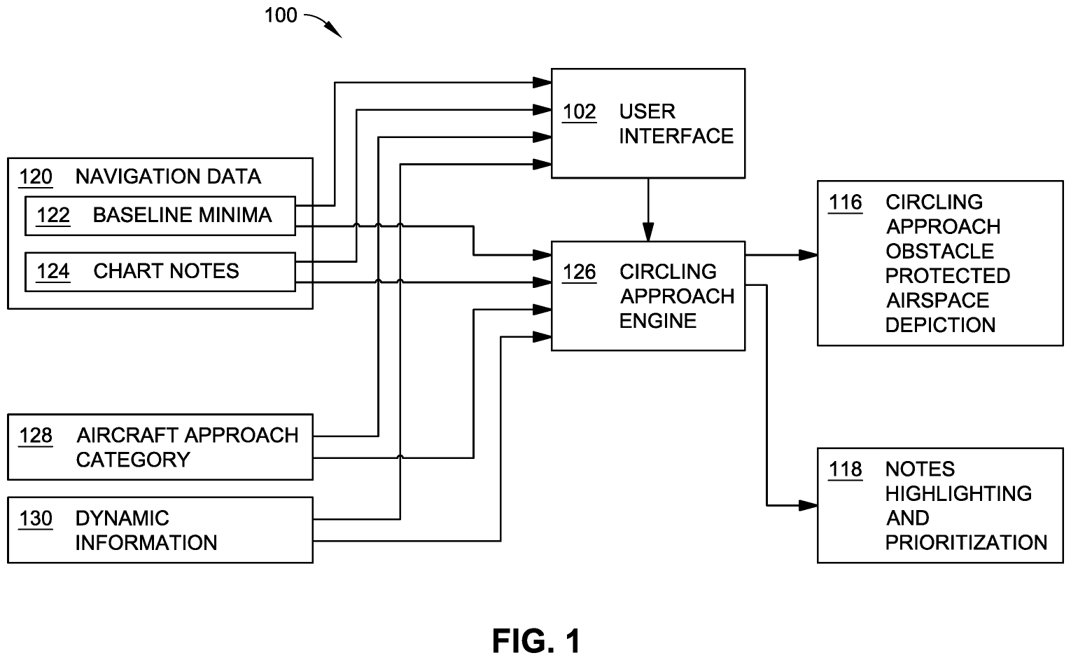

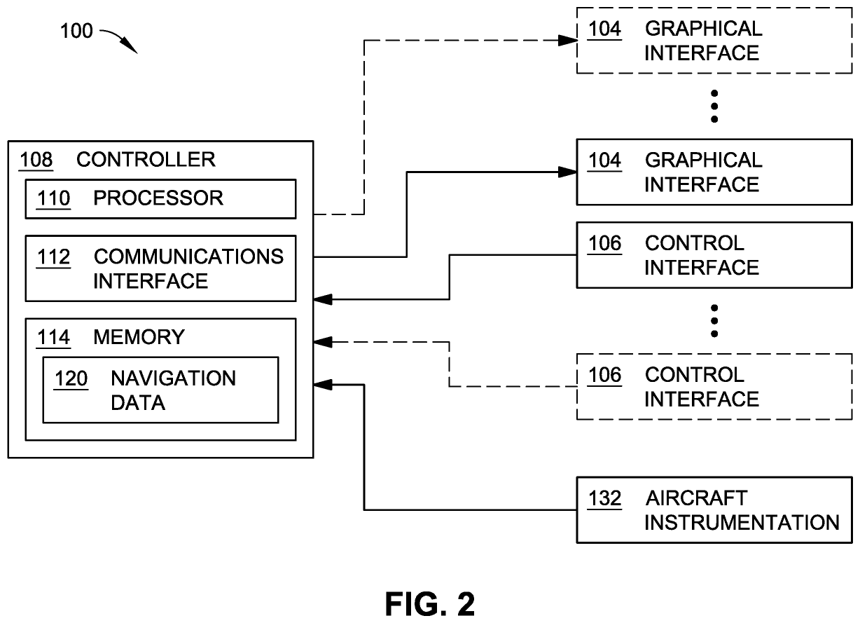

FIGS. 1 and 2 illustrate an example embodiment of a flight deck system (e.g., integrated avionics system 100) within an aircraft. The integrated avionics system 100 generally includes a user interface 102 having a graphical interface 104 and a control interface 106. The integrated avionics system 102 also includes a controller 108 having a processor 110, a communications interface 112, and a non-transitory computer-readable storage medium (e.g., memory 114).

The user interface 102 includes graphical interface 104 for displaying information and control interface 106 that allows a pilot (e.g., pilot, co-pilot, and/or other aircraft operator) to provide input. In some embodiments, the control interface 106 is a touch screen interface, such as an electronic visual display that incorporates a touch panel overlying an electronic display to detect the presence and/or location of a touch within the display area of the screen. In these embodiments, the pilot can provide input using an instrument such as a finger, a stylus, and so forth. In some embodiments, the control interface 106 allows the pilot to provide to provide non-touch input via one or more keyboards, cursors, buttons, knobs, dials, control columns, and so forth.

The graphical interface 104 includes a display, such as an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information on a display screen. The display screen can be backlit via a backlight such that it can be viewed in the dark or other low-light environments. In some embodiments, the graphical interface 104 can be disposed on an instrument panel of the aircraft, a pedestal area of the aircraft, an outboard area of the aircraft, and so forth. In embodiments, the integrated avionics system 100 can include one or more graphical interfaces 104 with corresponding displays for providing differing functionality including, but not limited to: PFD(s), MFD(s), head up display(s) (HUDs), secondary display unit(s) (SDUs), CDU(s), PED(s), electronic flight bag(s) (EFBs), and so forth. The graphical interfaces 104 may furnish a general-purpose pilot interface to control the aircraft's avionics. For example, the graphical interfaces 104 allow the pilot to control various systems of the aircraft such as the aircraft's flight management system, autopilot system, navigation systems, communication systems (e.g., controller pilot data link communications system [CDPLC], automatic dependent surveillance-broadcast [ADS-B], aircraft communications addressing and reporting system [ACARS], airborne satellite communications systems [SATCOM], other data link systems, other ground-ground communication systems, etc.), engines, and so on, via the avionics data bus. In implementations, the avionics data bus may include a high-speed data bus (HSDB), such as data bus complying with ARINC 429 data bus standard promulgated by the Airlines Electronic Engineering Committee (AEEC), a MIL-STD-1553 compliant data bus, and so forth.

The control interface 106 can be coordinated with the graphical interface 104 for entry of data and commands. In embodiments including a touch screen interface, the operator may use his or her fingers to manipulate images and/or selectable items on the graphical interface 104. The control interface 106 can be disposed on the graphical interface 104, external to the graphical interface 104, or a combination thereof. In some embodiments, the graphical interface 104 is operable by a combination of direct touch received via the touch screen interface and input received external to the graphical interface 104.

In embodiments including a touch screen interface, the control interface 106 includes a touch surface. For example, the touch surface can be a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens can include surface capacitance touch screens, projected capacitance touch screens, mutual capacitance touch screens, and self-capacitance touch screens. In implementations, the touch surface is configured with hardware to generate a signal to send to a processor and/or driver upon detection of touch information (e.g., a touch input). As indicated herein, touch inputs include inputs, gestures, and movements where the input contacts the touch surface. In embodiments, the control interface 106 can receive touch information from an operator (e.g., user such as a pilot and/or a co-pilot) to interact with the graphical interface 104 displayed on the display screen. In some embodiments, the graphical interface 104 may include both active portions (e.g., areas that are responsive to operator touch information) and non-active portions (e.g., areas that are not responsive to operator touch information). In implementations, keyboards, cursors, buttons, softkeys, keypads, knobs and so forth, may be used for entry of data and commands instead of or in addition to the touch surfaces.

In embodiments, the graphical interface 104 is configured for displaying flight information. In some embodiments, the flight information includes information related to a flight plan and/or aeronautical charts for the aircraft. As described below, flight information can include a circling approach obstacle protected airspace depiction 116 related to a published circling approach for the aircraft, and notes, highlighting, or prioritization information 118 related thereto. In some embodiments, the flight-related information is displayed in one or more primary flight windows (PFWs), one or more multifunction windows (MFWs), or a combination thereof. The PFWs may be configured to display primary flight information, such as aircraft attitude, altitude, heading, vertical speed, and so forth. In embodiments, the PFWs may display primary flight information via a graphical representation of basic flight instruments such as an attitude indicator, an airspeed indicator, an altimeter, a heading indicator, a course deviation indicator, and so forth. The PFWs may also display other flight-related information providing situational awareness to the pilot such as terrain information, ground proximity warning information, weather information, and so forth.

In embodiments, The MFWs display interactive flight-related information 106 describing operation of the aircraft such as navigation routes, moving maps, engine gauges, weather radar, terrain alerting and warning system (TAWS) displays, ground proximity warning system (GPWS) displays, traffic collision avoidance system (TCAS) displays, airport information, and so forth, that are received from a variety of aircraft systems via the avionics data bus and/or are self-contained within the user interface 102. In some embodiments, the PFW may provide the functionality of an MFW. Where the system 100 includes multiple MFWs, MFWs that control a common systemwide value/state can be cross-filled when multiple instances viewing this value are active substantially simultaneously. Further, the graphical interface 104 may be capable of displaying multiple instances of the same application in multiple MFWs, for example, with no restrictions on the number of the same application that could be displayed substantially simultaneously. In some embodiments, MFWs and/or PFWs shall support display and/or control of third-party applications (e.g., video, hosted applications, ARINC 661, etc.).

In embodiments, the EFB displays interactive flight-related information 106 in a similar manner to MFWs and/or PFWs described above, but in a portable and self-contained format. EFB may be a specific-purpose portable electronic device or an application running on a conventional electronic device such as a tablet computer or smartphone.

The controller 108 provides functionality to the user interface 102 via the processor 110, the communications interface 112, and the memory 114. The processor 110 can be operably and/or communicatively coupled with the graphical interface 104 and/or the control interface 106. The processor 110 can control the components and functions of the system 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the system 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The processor 110 provides processing functionality for the system 102 and can include any number of processors, micro-controllers, or other processing systems, and resident or external memory for storing data and other information accessed or generated by the system 100. The processor 110 can execute one or more software programs that implement techniques described herein. The processor 110 is not limited by the materials from which it is formed or the processing mechanisms employed therein and, as such, can be implemented via semiconductor(s) and/or transistors (e.g., using electronic integrated circuit (IC) components), and so forth.

The communications interface 112 is operatively configured to communicate with components of the system 100. For example, the communications interface 112 can be configured to transmit data for storage in the system 110, retrieve data from storage in the system 100, and so forth. The communications interface 112 is also communicatively coupled with the processor 110 to facilitate data transfer between components of the system 100 and the processor 110 (e.g., for communicating inputs to the processor 110 received from a device communicatively coupled with the system 100). It should be noted that while the communications interface 112 is described as a component of a system 100, one or more components of the communications interface 112 can be implemented as external components communicatively coupled to the system 100 via a wired and/or wireless connection. The system 100 can also include and/or connect to one or more input/output (I/O) devices (e.g., via the communications interface 112), including, but not necessarily limited to: a display, a mouse, a touchpad, a keyboard, and so on.

The communications interface 112 and/or the processor 110 can be configured to communicate with a variety of different networks, including, but not necessarily limited to: ARINC 429; RS-232; RS-422; CAN Bus; ARINC 661; a wide-area cellular telephone network, such as a 3G cellular network, a 4G cellular network, a 5G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 112 can be configured to communicate with a single network or multiple networks across different access points. The communications interface 112 can facilitate integration of aircraft alerts and/or notifications (e.g., notice to airmen [NOTAM], National Oceanic and Atmospheric Administration [NOAA] weather alerts, weather ship alerts, Safety Alerts, air-ground communications, etc.) with system 100.

The memory 114 is an example of tangible, computer-readable storage medium that provides storage functionality to store various data associated with operation of the system 100, such as software programs and/or code segments, or other data to instruct the processor 110, and possibly other components of the system 100, to perform the functionality described herein. Thus, the memory 114 can store data, such as a program of instructions for operating the system 100 (including its components), and so forth. It should be noted that while a single memory 114 is described, a wide variety of types and combinations of memory (e.g., tangible, non-transitory memory) can be employed. The memory 114 can be integral with the processor 110, can include stand-alone memory, or can be a combination of both.

The memory 114 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 114 can include removable integrated circuit card (ICC) memory, such as memory provided by a subscriber identity module (SIM) card, a universal subscriber identity module (USIM) card, a universal integrated circuit card (UICC), and so on. In embodiments, the memory 114 includes one or more software modules capable of being executed by the processor 110, and one or more data sets and/or databases. In embodiments, the memory 114 includes one or more software modules capable of being executed by the processor 110, and one or more data sets and/or databases.

The memory 114 is operable to store a database of flight-related information associated with a flight plan and/or aeronautical charts for an aircraft. In some embodiments, flight-related information includes electronic representations of aeronautical charts (e.g., circling approaches including line of minima on a straight-in approach, other instrument approach charts, airport diagrams, departure procedure charts, standard terminal arrival charts, charted visual flight procedure charts, etc.) describing procedures and information for operating the aircraft under specified circumstances (e.g., in proximity to an airport). In a specific embodiment, the flight-related information includes electronic representations of circling approaches. Each electronic representation of a circling approach is described by navigation data 120 for operating the aircraft in proximity to an airport. For example, navigation data 120 can include one or more minima (e.g., baseline minima 122) corresponding to circling restrictions (e.g., lateral area restrictions, runway restrictions, other airspace authorization restrictions, etc.) associated with the circling approach for an airport. Baseline minima 122 can include, but are not limited to ceiling minimum, required obstacle clearance (ROC), minimum obstacle clearance (MOC), Obstacle Limitation Surface (OLS), circling radii, visibility minimum, other minima describing protected airspace, and so forth. Navigation data 120 can also include conditional criteria associated with the baseline minima 122 including, but not limited to adjustments based on operational characteristics of the aircraft (e.g., approach lighting, altimeter, flight director, etc.) and/or ground devices or other runway equipment (e.g., visual glide slope indicators [VGSI], etc.), and procedural chart notes 124 (e.g., instructional notes associated with the approach such as instrument-specific notes, visibility notes, temperature notes, restrictions, etc.), and so forth. It is to be understood that navigation data 120 can also include additional data related to the operation of the aircraft.

Still referring to FIGS. 1 and 2, the system 100 includes a circling approach engine 126 that is stored in the memory 114 and executable by the processor 110. In embodiments, the circling approach engine 126 is operable to determine, based on the stored navigation data 120 and one or more condition associated with the aircraft, an applicable circling approach obstacle protected airspace depiction 116. Depiction 116 may additionally or alternatively represent special not authorized circling radii depictions including circling radii. In some embodiments, the condition associated with the aircraft includes an operational characteristic. Operational characteristics can include, but are not limited to an aircraft approach category 128 or other aircraft speed characteristic, an altitude characteristic, a flight angle characteristic (e.g. VGSI angle, Vertical Descent Angle [VDA], etc.) and so forth. In some embodiments, the operational characteristic includes an operational status of an aircraft system, aircraft instrument, and/or ground device. For example, the condition can include an inoperative component indicating a non-operational status of an aircraft system, aircraft instrument (e.g., approach light system, touch down zone lights, runway centerlight system, altimeter, etc.), and/or ground device (e.g., VGSI). The condition associated with the aircraft can also include an environmental characteristic. Environmental characteristics can include, but are not limited to temperature, precipitation type/level, wind speed, wind direction, weather rating, time of day, and so forth. The condition of the aircraft can also include dynamic information 130 associated with a real-time characteristic of the aircraft such as information related to notifications associated with the aircraft (e.g., NOTAMs, NOAA weather alerts, weather ship alerts, Safety Alerts, air-ground communications, etc.), a real-time operating characteristic of the aircraft (e.g., true airspeed, etc.), a real-time environmental characteristic (e.g., a current weather condition), and so forth. It is contemplated that, in some embodiments, non-dynamic conditions of the aircraft are storable via the memory 114 and available for future use. It is to be understood that the terminology “conditions associated with the aircraft” and “information associated with the aircraft” also includes conditions/information associated with the related environment including, but not limited to weather conditions, airport/ground conditions, and so forth.

The condition(s) associated with the aircraft can be received by the circling approach engine 126 from a variety of sources. In some embodiments, the condition can be manually entered by the pilot via the control interface 106. For example, the graphical interface 104 can be configured to display one or more selectable items corresponding with conditions of the aircraft, as described below.

In some embodiments, the condition is received directly from an aircraft system or instrument including, but not limited to basic aircraft instruments (e.g., attitude indicator, an airspeed indicator, an altimeter, a heading indicator, a course deviation indicator, etc.), aircraft warning systems (e.g., TAWS, TCAS, GPWS, etc.), aircraft control systems (e.g., flight management system, autopilot system, navigation systems, communication systems, etc.), aircraft information systems (e.g., air data computers, etc.) and so forth. In a specific embodiment, the condition is received from an air traffic controller via the CDPLC, other data link system, or other ground-ground communication system. In some embodiments, the system 100 includes one or more sensors for providing data associated with a condition of the aircraft via the controller 108. In these embodiments, aircraft systems, instruments, and/or sensors can be utilized to provide real-time data associated with a dynamic condition of the aircraft. As noted above, it is further contemplated that non-dynamic conditions of the aircraft may be preselected and retrievable from the memory 114.

In embodiments, the circling approach engine 126 is operable to compare the condition(s) associated with the aircraft to the baseline minima 122 and/or conditional criteria (e.g., chart notes 124, operational characteristics, environmental characteristics, etc.), and identify an applicable circling approach. For example, the ceiling approach engine 126 can determine the applicable circling approach by adjusting the baseline minima 122 (e.g., ceiling minimum, ROC, MOC, OLS, circling radii, visibility minimum, etc.) based on predetermined adjustment factors associated with the conditional criteria. The processor is operable via the circling approach engine 126 to, for example, compare an aircraft approach category 128 for the aircraft with published circling radii and determine an applicable circling radius for the aircraft. The processor is further operable to generate an applicable circling approach obstacle protected airspace depiction 116) based on the applicable circling approach. It is to be understood that the terms “visibility minimum” and “visibility minima” are used herein to describe any minimum associated with the visual identification and/or recognition of objects. Examples of visibility minima include, but are not limited to: visibility, Runway Visual Range (RVR), and so forth. It is to be further understood that the terms “ceiling minimum” and “ceiling minima” are used herein to describe any minimum associated with aircraft altitude. Example of ceiling minima include, but are not limited to: circling minimum descent altitude (CDMA), maximum density altitude, descent altitude (DA), minimum descent altitude (MDA), and so forth.

In embodiments, the processor 110 is operable to display, via the graphical interface 104, the applicable circling approach obstacle protected airspace depiction 116 to the pilot. The circling approach obstacle protected airspace depiction 116 provides a visual representation of the circling approach and/or airspace authorization restrictions associated with the circling approach. In some embodiments, the processor 110 is operable to display real-time adjustments to the applicable circling approach obstacle protected airspace depiction 116. For example, the processor 110 may cause the graphical interface 104 to initially display a published circling approach obstacle protected airspace depiction associated with the airport, and then display the real-time adjustments to represent the applicable depiction 116 as the circling obstacle engine 126 determines the applicable circling approach based on the conditions associated with the aircraft. In some embodiments, the processor 110 is operable to display additional data corresponding to the electronic representations of charts and/or the condition(s) associated with the aircraft, as described below.

In some embodiments, the processor 110 is operable to display via the graphical interface 104, procedural notes 124 or other clarifying information related to the applicable circling approach obstacle protected airspace depiction 116 and/or the corresponding electronic chart representation. The processor 110 is further operable, via the circling approach engine 126, to identify a highlighting or other prioritization of the graphical interface 104 based on the applicable circling approach obstacle protected airspace depiction 116 (e.g., notes highlighting and prioritization 118), as described below. The processor 110 may be further operable to dynamically reconfigure the highlighting and/or prioritization arrangement of the graphical interface 104 based on corresponding changes in the priority of the procedural notes 124.

### Example Display Embodiments

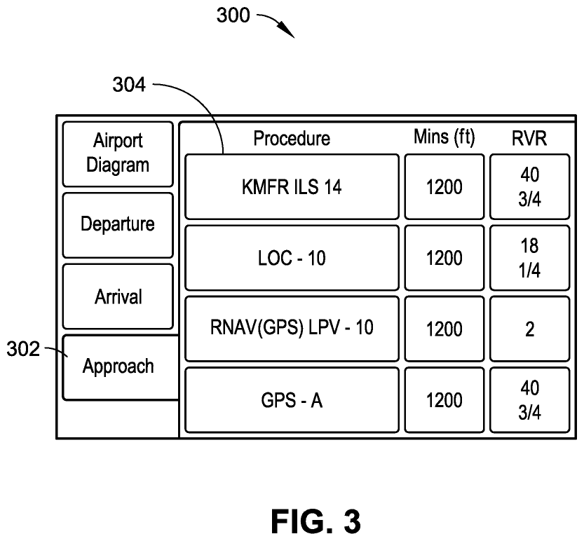

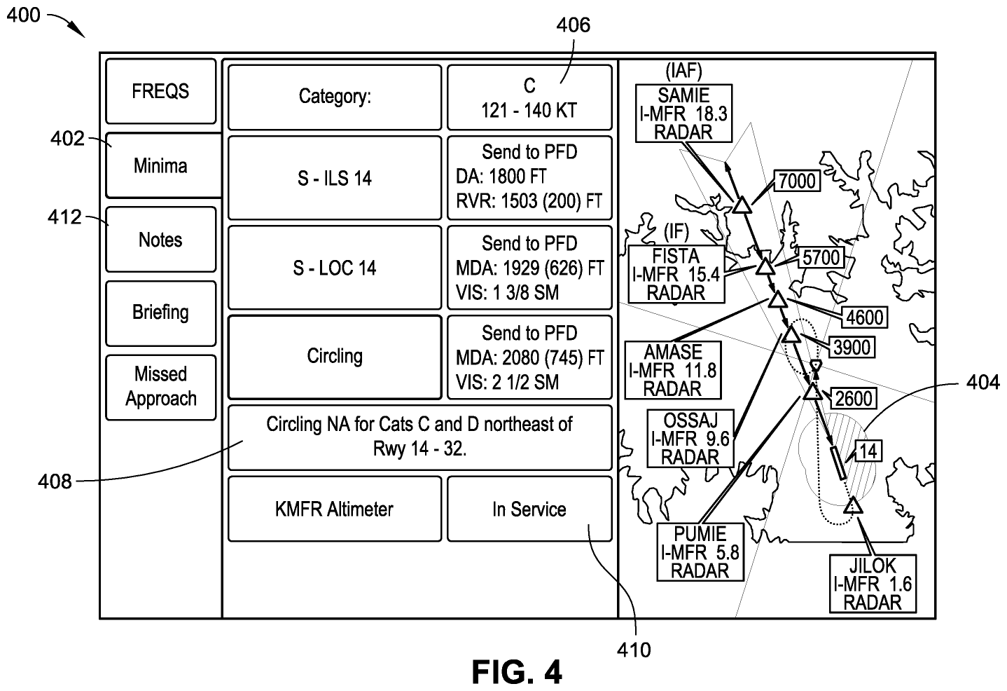

FIGS. 3 and 4 illustrate example displays 300, 400 for furnishing flight information to the pilot, and configured to receive input from the pilot and provide functionality for the pilot to engage with the graphical interface 104. For example, the display 300, 400 can include information related to the flight plan, instrument charts, or other flight-related information.

In embodiments, the display 300, 400 can include one or more selectable items (buttons, selectable menus, etc.) arranged on the graphical interface 104 for receiving input from the pilot. The selectable items can correspond to one of the electronic representations of charts. For example, the display 300 can include selectable menu item (e.g., approach menu item 302; as describe with reference to FIG. 3) for receiving a selection of a flight phase (e.g., departure, arrival, approach, etc.). Based on the pilot's selection of flight phase (e.g., approach menu item 302), the processor 110 will populate the graphical interface 104 with selectable items related to the selected flight phase. Such selectable items can include, for example, one or more selectable buttons (e.g., procedure button 304) for receiving a selection of a flight procedure and/or airport associated with the selected flight phase.

Based on the selection of a flight phase, procedure, and/or airport, the processor 110 may cause additional interactive flight information to be displayed via the graphical interface 104, the additional interactive flight information corresponding to an electronic chart representation associated with the selected flight phase and/or procedure. In some embodiments, the display 400 may include one or more selectable menu item (e.g., minima menu item 402, notes menu item 412, etc.) for displaying interactive flight information corresponding to the flight chart (e.g., as described with reference to FIG. 4). Based on a selection of the minima button 402, for example, the processor 110 populates the graphical interface 104 with one or more selectable condition inputs for receiving input related to a condition of the aircraft (e.g., condition inputs 406, 410).

The condition inputs 406, 410 receive information about conditions of the aircraft corresponding to the baseline minima 122 and associated conditional criteria for the particular electronic chart representation. In some embodiments, the condition inputs receive information about an inoperative component of the aircraft (e.g., condition input 410. For example, the display 400 includes one or more aircraft instruments (e.g., KMFR Altimeter) used for the selected procedure, and corresponding condition input 410 for entry of an “In Service” or “Out of Service” status. In some embodiments, the condition inputs receive information about an environmental characteristic (e.g., temperature, precipitation type/level, wind speed, wind direction, weather rating, time of day, restricted air space, etc.) associated with the aircraft. In some embodiments, the condition inputs receive information about other operational characteristics (e.g., approach category or other aircraft speed characteristic, altitude characteristic, etc.) associated with the aircraft (e.g., condition input 406). For example, the condition input can receive a selection of an aircraft approach category 128 (e.g., as described with reference to FIG. 1) associated with the aircraft (e.g., condition input 406). Condition inputs related to operational characteristics can also include functionality to “enable” or “disable” further minima adjustments based on procedural notes associated with the conditional criteria for the electronic chart representation.

It is to be understood that, while specific condition inputs are shown in FIG. 4, the display 400 may include additional condition inputs. Such additional conditional inputs can include, but are not limited to stepdown fix input, day/night input, tower status input, restricted airspace input, simultaneous runway operations input, other condition inputs customizable to the corresponding electronic chart representation, and so forth.

The display 400 further includes a visual depiction of the circling approach obstacle protected airspace 404. The circling approach obstacle protected airspace depiction 404 provides a visual representation of the circling restrictions associated with the circling approach. As described above, circling approach obstacle protected airspace depiction 404 is generated based on the baseline minima 122 and conditional criteria associated with the electronic chart representation, and the condition information received via the graphical interface 104. The circling approach obstacle protected airspace depiction 404 may include, for example, a visual depiction of a circling area or circling radius associated with the airport runway. In some embodiments, the circling approach obstacle protected airspace depiction 404 includes a visual depiction (e.g., bars, highlighting, etc.) of unauthorized portions of the circling area. In specific embodiments, the circling approach obstacle protected airspace depiction 404 is displayed to scale, for example, on a map or moving map of the display.

In some embodiments, the display 400 is configured to dynamically recreate the circling approach obstacle protected airspace depiction 404 as the baseline minima 122 and conditional criteria are adjusted based on condition inputs received from the pilot, aircraft instrumentation, aircraft systems, aircraft sensors, aircraft communication systems, and so forth. In specific embodiments, the circling approach obstacle protected airspace depiction 404 is dynamically reconfigured based on dynamic information 130 associated with the aircraft (e.g., true airspeed, NOTAMs, etc.) received via the control interface 106 and/or via aircraft instrumentation, aircraft systems, aircraft sensors, and so forth. In some embodiments, the display 400 further includes one or more ceiling minimum and/or visibility minimum associated with the circling approach obstacle protected airspace depiction 404.

In some embodiments, the processor 110 is operable to display via the graphical interface 104, procedural notes or other clarifying information related to the displayed circling approach obstacle protected airspace depiction 404 and/or the corresponding electronic chart representation. Such procedural notes may include navigational equipment required for the selected procedure, approach authorization information, other navigational notes related to the procedure, and so forth. The processor 110 is further operable, via the circling approach engine 126, to identify a highlighting or other prioritization of the graphical interface 104 based on the circling approach obstacle protected airspace depiction 404. For example, display 400 may feature notes of high priority (e.g. note 408) in highlighting and/or arrange such notes 408 in a prioritized position (e.g., on the minima menu option 402, at the top of a notes window of the display 400, etc.). Such highlighting and/or prioritization can be utilized to indicate importance and/or hierarchical order of procedural notes, allowing the pilot to quickly identify critical information and reducing heads-down time. In a specific embodiment, a prioritized note 408 is displayed on the window associated with the minima menu option 402, while notes of lower priority are viewable by selecting the notes menu option 412. As described above, the highlighting and/or prioritization arrangement of the display 400 can be dynamically reconfigured to reflect corresponding changes in the priority and/or importance of procedural notes.

It is to be understood that the display 300, 400 can be configured to receive one or more types of pilot input via the control interface 106. In some embodiments, the display 300, 400 is configured for touch inputs (buttons, selectable menus, etc.) received via a touch surface. In other embodiments, pilot input can be received from other input devices (buttons, cursors, bezels, wheels, etc.) of the integrated avionics system 100. Additionally, features of the displays 300, 400 of the graphical interface 104 and the other input devices can be configured based on the specifications of the aircraft to provide an accessible and user-friendly interface. It is to be further understood that the display 300, 400 can be configured to display condition information received from a variety of sources including, but not limited to: pilot input, data received from other aircraft systems, data received from aircraft instrumentation, data received from aircraft sensors, aircraft communication systems, and so forth.

### Example Processes

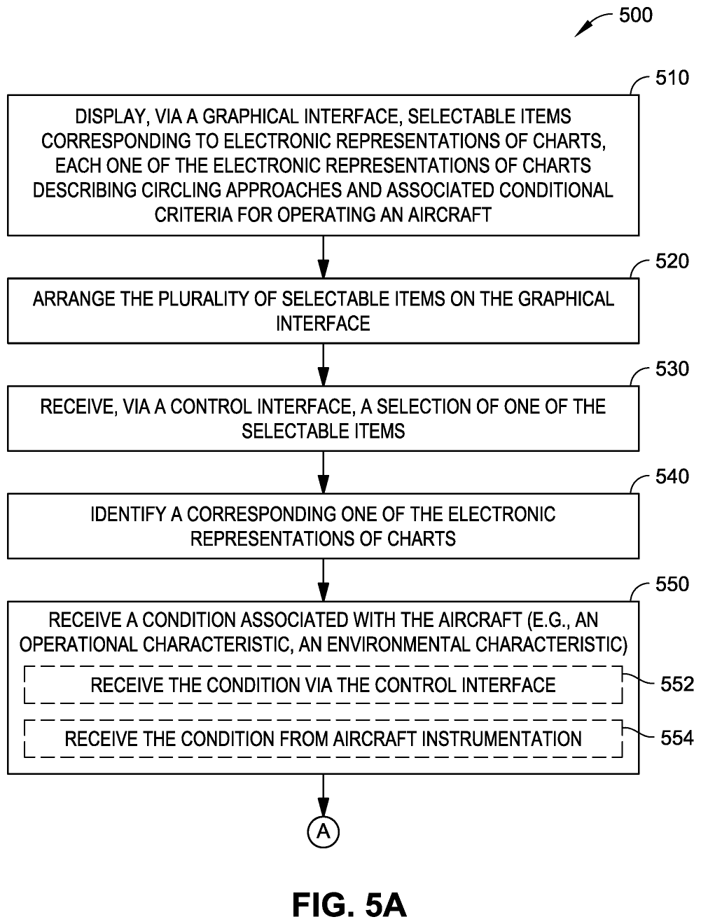

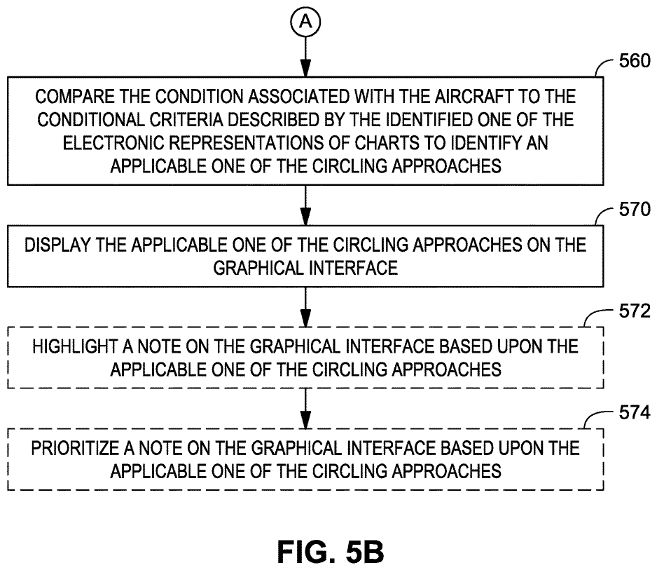

FIGS. 5A through 5B depict an example method 500 for operating a flight deck system, such as integrated avionics system 100, to determine an applicable circling approach. As shown in FIG. 5A, one or more selectable items are displayed via the graphical interface 104 (Block 510). Each of the selectable items corresponds to one of the electronic representations of charts (e.g., circling approaches) stored via memory 114. As described above, each electronic chart representation describes navigation data 120 associated with an airport. For example, navigation data 120 includes circling restrictions (e.g., lateral area restrictions, runway restrictions, other airspace authorization restrictions, etc.) and corresponding minima, such as baseline minima 122 (e.g., ceiling minimum, ROC, MOC, OLS, circling radii, visibility minimum, etc.) associated with the circling approaches. Navigation data 120 can also include conditional criteria associate with the circling approaches including, but not limited to adjustments for operational characteristics (e.g., aircraft instrumentation, ground equipment, inoperative components, etc.), procedural chart notes 124 (e.g., instructional notes associated with the approach such as instrument-specific notes, temperature notes, etc.), and so forth. The selectable items are arranged on the graphical interface 104 (Block 520).

A selection is received, via control interface 106, of one of the selectable items (Block 530). In some embodiments, the control interface 106 is configured for touch inputs (buttons, selectable menus, etc.) received via a touch surface. In other embodiments, input can be received from other input devices (buttons, cursors, bezels, wheels, etc.) of the integrated avionics system 100. Based on the selection, a corresponding electronic chart representation is identified (Block 540). For example, based on a pilot selection of an approach procedure, the processor 110 is operable to identify a corresponding electronic chart representation.

A condition associated with the aircraft is received (Block 550). As described above, the condition can include an operational characteristic (e.g., aircraft approach category 128 or other aircraft speed characteristic, an altitude characteristic, inoperative component, etc.) and/or an environmental characteristic (e.g., temperature, precipitation type/level, wind speed, wind direction, weather rating, time of day, restricted air space, etc.). In some implementations, the condition can include dynamic information 130 associated with a real-time characteristic of the aircraft (e.g., true airspeed, NOTAMs, etc.).

The condition associated with the aircraft can be received from a variety of sources. In some implementations, the condition is received via the control interface 106 (Block 552). For example, the condition may be received via touch input and/or other input device. Alternatively, the condition may be received directly from aircraft instrumentation (Block 554). For example, the condition may be received directly, via the controller 108, from aircraft instrumentation, aircraft communication systems, other aircraft systems, or aircraft sensors.

The condition associated with the aircraft is compared to the conditional criteria described by the electronic chart representation to identify one or more applicable circling restrictions (e.g., lateral area restrictions, runway restrictions, etc.) associated with the circling approach for an airport (Block 560). In implementations, the processor is operable, via the circling approach engine 126 to compare the aircraft condition with the stored baseline minima 122 and associated conditional criteria. Based on this comparison, the baseline minima 122 are adjusted to generate the applicable circling approach (e.g., circling approach obstacle protected airspace).

The circling approach and/or associated circling restrictions are displayed on the graphical interface 104 (Block 570). In implementations, the processor 110 is operable to display, via the graphical interface 104, the applicable circling approach obstacle protected airspace depiction 116. The applicable circling approach obstacle protected airspace depiction 116 provides a visual representation of the circling restrictions associated with the circling approach. The circling approach obstacle protected airspace depiction 116 may include, for example, a visual depiction of a circling area or circling radius associated with the airport runway(s). In some embodiments, the circling approach obstacle protected airspace depiction 116 further includes a visual depiction (e.g., bars, highlighting, etc.) of unauthorized portions of the circling area. In specific embodiments, the processor 110 is operable to display, via the graphical interface 104, the circling approach obstacle protected airspace depiction 116 to scale, for example, on a map or moving map of the display (electronic moving map). In some embodiments, the graphical interface 104 is operable, via the processor 110, to dynamically recreate the displayed circling approach obstacle protected airspace depiction 116 as the baseline minima 122 and conditional criteria are adjusted based on aircraft condition information received from the pilot, aircraft instrumentation, aircraft systems, aircraft sensors, and so forth.

In some implementations, one or more procedural notes (e.g., notes 124) based upon the electronic chart representation and/or the applicable circling approach are displayed. Such notes 124 may include navigational equipment required for the selected procedure, approach authorization information, other navigational notes related to the circling approach, and so forth. In some implementations, a note 124 is highlighted on the graphical interface 104 based on the applicable circling approach and/or circling restrictions (Block 572). In some implementations, a note 128 is prioritized on the graphical interface 104 based upon the applicable circling approach and/or circling restrictions (Block 574). For example, a prioritized note may be displayed in a prominent position on a minima window of the graphical interface 104, and/or at the top of a notes window of the graphical interface 104. In such implementations, the processor 110 is operable, via the circling approach engine 126, to identify such highlighting or other prioritization of the graphical interface 104 (e.g., notes highlighting and prioritization 118) to indicate importance and/or hierarchical order of notes 124.

It is to be understood that the terms “operator” and “pilot” are used interchangeably herein to describe any pilot, co-pilot, crew member, or other person who operates or controls the aircraft.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A flight deck system for an aircraft, the flight deck system comprising:
a processor;
a graphical interface for displaying flight-related information, the flight-related information including a plurality of selectable items arrangeable on the graphical interface, each one of the plurality of selectable items corresponding to one of a plurality of electronic representations of charts, each one of the plurality of electronic representations of charts describing a plurality of circling approaches and associated conditional criteria for operating the aircraft proximate to an airport;
a control interface for receiving a selection of one of the plurality of selectable items; and
a non-transitory computer-readable storage medium for storing the plurality of electronic representations of charts, the non-transitory computer-readable storage medium having computer executable instructions stored thereon for execution by the processor to
arrange the plurality of selectable items on the graphical interface,
receive a selection of one of the plurality of selectable items,
in response to the selection, identify a corresponding one of the plurality of electronic representations of charts,
receive at least one condition associated with the aircraft,
compare the at least one condition associated with the aircraft to the conditional criteria for operating the aircraft described by the identified one of the plurality of electronic representations of charts to identify an applicable one of the plurality of circling approaches, and
display the applicable one of the plurality of circling approaches on the graphical interface, wherein the applicable one of the plurality of circling approaches is displayed to scale on a map.

2. The flight deck system as recited in claim 1, wherein the at least one condition associated with the aircraft comprises at least one of an operational characteristic or an environmental characteristic.

3. The flight deck system as recited in claim 1, wherein the applicable one of the plurality of circling approaches comprises at least one of a circling lateral area restriction or a runway restriction.

4. The flight deck system as recited in claim 1, wherein the computer executable instructions are configured to cause the processor to identify at least one of a highlighting or a prioritization for the graphical interface based upon the applicable one of the plurality of circling approaches.

5. The flight deck system as recited in claim 1, wherein the at least one condition is received via the control interface.

6. The flight deck system as recited in claim 5, wherein the at least one condition comprises an aircraft approach category.

7. The flight deck system as recited in claim 1, wherein the at least one condition is received from aircraft instrumentation or an aircraft communication system.

8. A flight deck system for an aircraft, the flight deck system comprising:
a processor;
a graphical interface for displaying flight-related information, the flight-related information including a plurality of selectable items arrangeable on the graphical interface, each one of the plurality of selectable items corresponding to one of a plurality of electronic representations of charts, each one of the plurality of electronic representations of charts describing a plurality of circling approaches and associated conditional criteria for operating an aircraft;
a control interface for receiving a selection of one of the plurality of selectable items; and
a non-transitory computer-readable storage medium for storing the plurality of electronic representations of charts, the non-transitory computer-readable storage medium having computer executable instructions stored thereon for execution by the processor to
arrange the plurality of selectable items on the graphical interface,
receive a selection of one of the plurality of selectable items,
in response to the selection, identify a corresponding one of the plurality of electronic representations of charts,
receive at least one condition associated with the aircraft,
compare the at least one condition associated with the aircraft to the conditional criteria for operating the aircraft described by the identified one of the plurality of electronic representations of charts to identify an applicable one of the plurality of circling approaches, and
display the applicable one of the plurality of circling approaches on the graphical interface to scale on a map.

9. The flight deck system as recited in claim 8, wherein at least one of the plurality of selectable items comprises an identification of an airport.

10. The flight deck system as recited in claim 8, wherein the at least one condition associated with the aircraft comprises at least one of an operational characteristic or an environmental characteristic.

11. The flight deck system as recited in claim 8, wherein the applicable one of the plurality of circling obstacles is displayed on the graphical interface to scale.

12. The flight deck system as recited in claim 8, wherein the applicable one of the plurality of circling approaches comprises at least one of a circling lateral area restriction or a runway restriction.

13. The flight deck system as recited in claim 8, wherein the computer executable instructions are configured to cause the processor to identify at least one of a highlighting or a prioritization for the graphical interface based upon the applicable one of the plurality of circling approaches.

14. The flight deck system as recited in claim 8, wherein the at least one condition is received via the control interface.

15. The flight deck system as recited in claim 14, wherein the at least one condition comprises an aircraft approach category.

16. The flight deck system as recited in claim 8, wherein the at least one condition is received from aircraft instrumentation or an aircraft communication system.

17. A method comprising:
displaying, via a graphical interface for flight-related information, a plurality of selectable items, each one of the plurality of selectable items corresponding to one of a plurality of electronic representations of charts, each one of the plurality of electronic representations of charts describing a plurality of circling approaches and associated conditional criteria for operating an aircraft;
arranging the plurality of selectable items on the graphical interface;
receiving, via a control interface, a selection of one of the plurality of selectable items;
in response to the selection, identifying a corresponding one of the plurality of electronic representations of charts;
receiving at least one condition associated with the aircraft, the at least one condition associated with the aircraft including at least one of an operational characteristic or an environmental characteristic;
comparing the at least one condition associated with the aircraft to the conditional criteria for operating the aircraft described by the identified one of the plurality of electronic representations of charts to identify an applicable one of the plurality of circling approaches; and
displaying the applicable one of the plurality of circling approaches on the graphical interface to scale on a map.

18. The method as recited in claim 17, wherein displaying the applicable one of the plurality of circling approaches on the graphical interface comprises displaying the applicable one of the plurality of circling obstacles to scale.

19. The method as recited in claim 17, wherein the at least one condition is received via the control interface.

20. The method as recited in claim 17, wherein the at least one condition is received from aircraft instrumentation or an aircraft communication system.
